(19) United States
(12) Patent Application Publication
(10) Pub. No.: US 2004/0081086 A1
(43) Pub. Date: Apr. 29, 2004

(54) Method for redirecting packet data traffic to an alternative access point/router

(76) Inventors: Lassi Hippelainen, Helsinki (FI); Otso Auterinen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/466,253

(22) PCT Filed: Jan. 15, 2002
(86) PCT No.: PCT/FI02/00031

(30) Foreign Application Priority Data
Jan. 16, 2001 (FI) 20010095

(51) Int. Cl. H04L 1/00

(52) U.S. Cl. 370/227

(57) ABSTRACT

The invention relates to a method of protecting a data link (1-10, 1-20) established via an access point (GGSN1, GGSN2, ROUTER1, ROUTER2) to a mobile subscriber node (MN). The invention further includes the steps in which: (i) a monitoring network element (HA) observes the operation of the data link (1-10, 1-20); and (ii) in case the operation of the data link (1-10, 1-20) becomes unsuitable for communication, the monitoring network element (HA) starts to set up an alternative data link (1-10, 1-20) via an alternative access point (GGSN1, GGSN2, ROUTER1, ROUTER2).

### BACKGROUND OF THE INVENTION

The invention relates to a method of protecting a data link, the method enabling the establishment of a data link to a mobile subscriber node via one access point at a time, the access points being parallel and possibly belonging to wireless access networks employing different technologies.

In packet-switched data transfer, data is transferred split into packets, each of which contains payload, and source and destination addresses. Each packet is routed independently through a packet-switched network on the basis of said address data. In other words, data packets associated with the same communication may propagate along different routes and at different delays from the source to the destination, depending on the load on the network. Packet-switched technology searches for the fastest data link that is most economic in view of the total load on the network. A packet-switched network does not get paralyzed because of malfunction of individual network nodes or transmission links, as data packets are routed past network defects. This property is one of the basic reasons for the development of, for example, the Internet protocol, originally for military applications. In packet-switched wireless access networks, such as the GPRS (General Packet Radio Service) and WLAN (Wireless Local Area Network), subscribers may move within the network area and from one network to another, causing a change in their access point to the network. As other mobile networks, packet-switched wireless networks also require the implementation of some kind of mobility or location management in order for data packets to be routed to a mobile station's current access point in the network. Data packets arriving from outside an access network, such as the Internet, usually arrive at a special access node, which is for example a gateway or router between the access network and the outside network. This access node transfers the data packets on to the current access point utilizing the mobility management of the wireless access network.

The architecture of, for example, a GPRS network comprises different GPRS support nodes, such as a GGSN (GPRS gateway support node) and an SGSN (GPRS serving support node). The nodes are interlinked by an intra-operator backbone network, which is implemented by means of a local area network, such as an IP network. Data packets are tunnelled between nodes by means of a GPRS tunnelling protocol GTP. The basic functions of an SGSN node include detecting new mobile stations MS within its coverage area, managing the registration process of new terminals MS together with GPRS registers, transmitting data packets to and from an MS, and recording the locations of mobile stations MS within its area. The main function of a GGSN node is interaction with outside networks. The GGSN connects the operator to systems outside the GPRS network, such as other GPRS networks and data networks, such as the IP network (Internet). The GGSN includes a GPRS subscriber's PDP addresses (Packet Data Protocol) and routing information, i.e. SGSN addresses. The routing information is used for the GTP tunnelling of data packets arriving from an outside network to the MS's current access point, i.e. the serving SGSN node. To access a GPRS network, an MS first makes its presence known by a GPRS attach procedure. In this procedure, a logic link is established between the SGSN and the MS by setting up a mobility management (MM) context thereto. Furthermore, for the reception and transmission of GPRS data, the MS has to request for a PDP activation procedure. This makes the MS known to the corresponding GGSN. More precisely, one or more PDP contexts are created in the MS, the GGSN and the SGSN for determining different data transfer parameters, such as PDP type (for example IP), PDP address (for example IP address) and quality of service QoS. In other words, a PDP context between different GPRS nodes defines a GTP tunnel, which tunnel is between GGSN and SGSN. One GTP tunnel may include one or more PDP contexts.

In such a GPRS network, the GGSN constitutes a critical access point via which all data links from the Internet have to be established. For example, tunnelling IP data packets according to the mobility management protocol Mobile IP, created in the Internet, can be directed to a GGSN node. Should such a critical nodal point in an access network fail, the entire IP data link is in jeopardy, since a PDP context cannot be transferred to another GGSN node. The reliability of GGSN nodes should therefore be high; a hot standby unit, for example, could protect them. Some security measures exist for prior art IP networks. The Internet Engineering Task Force has provided the Internet with mobility properties by defining a Mobile IP protocol in standard RFC2002. The Mobile IP allows IP data packets (datagrams) to be routed to mobile hosts or nodes irrespective of their access point to the network. A mobile node's home IP network comprises a home agent HA, which is a kind of routing unit for maintaining location information on the mobile node and for tunnelling data packets to the right destination when the mobile node is outside its home network. In other words, a data packet addressed to the mobile node's IP home address is directed to the home agent HA, which encapsulates the data packet to another IP packet, in which the destination address is the tunnelling end point, ‘Care-of Address’ COA. RFC defines two different COA types: 1) ‘foreign agent COA’, the address of the network node in which the mobile node is registered, and 2) ‘co-located COA’, a temporary local IP address that the mobile node receives from the network. The mobile node registers the new COA in the home agent HA by transmitting a registration request. The encapsulation is called tunnelling, and a tunnel is the route along which the encapsulated IP data packet passes. One end of the tunnel may comprise a GPRS network GGSN node, for example. This network node de-capsulates the data packet and forwards it to the mobile node. In the case of a GGSN node, routing a data packet onwards takes place as described above for the GPRS network. When a mobile node replies to the sender, the IP reply packet is forwarded directly to a peer on the basis of its IP address. In more advanced versions of the Mobile IP, the home agent HA may give the mobile node's COA to the transmitting node, which allows direct tunnelling from the source by means of the COA. The source may for example request the COA from the home agent HA before it transmits an IP data packet to the mobile node.

If the mobile node supports the Mobile IP protocol, and the critical access node in the present network fails, the data link may be rerouted in accordance with the Mobile IP protocol via a second access point, an access concentrator, for example. In this case the host has to observe the release of the data link at the Mobile IP protocol layer and search for a new network or access node, open a network-level data link to this node and register the new COA in the home agent HA. Only after this does it continue communication over an alternative data link. A node moving in the GPRS system may start a new data link with another GGSN element and update the new IP address in the home agent HA. The Mobile IP protocol can also be used to support changeover over access networks. An example of this is changeover from the use of the GPRS technology to the use of WLAN technology.

However, the use of the Mobile IP protocol causes delay. Changeover takes a long time since detecting the loss of the first data link, finding an alternative route or access network, and opening a new data link each are complex operations involving many handshakes and time-outs.

Should the access point, such as the GGSN, serving the access network fail, the end user often loses all TCP/IP (Transmission Control Protocol/Internet Protocol) sessions linked through said element. This is because a mobile subscriber node does not detect the failure of a GGSN element soon enough, and, contrary to prior art solutions, is incapable of establishing an alternative compensating data link. In prior art arrangements, the time between losing a data link and setting up a new one is too long for certain services offered by the network to operate reliably.

### BRIEF DESCRIPTION OF THE INVENTION

The object of the invention is to provide a method and equipment for implementing the method so as to solve the above problem. The object of the invention is achieved by a method and system characterized by what is stated in the independent claims. The preferred embodiments of the invention are disclosed in the dependent claims.

The invention is based on activating the rerouting of a data link in malfunction from the network side instead of activating measures being taken by a mobile subscriber node. A monitoring element is arranged on the network side for monitoring the state of the critical access point used by the data link; if the operation of said access point becomes unreliable and/or unsuitable for communications, the monitoring network element starts to search for an alternative access point for the data link and shifts the data link to use the alternative access point found. This allows an error in the access point to be detected rapidly enough, for example more rapidly than time monitoring associated with an end-to end connection, and sessions may be saved since a new data link is opened in time through some other access point. In an embodiment of the invention, the monitoring element stores state data on the network element to be monitored, associated with the data link(s) to be protected. Owing to this, these state data do not have to be maintained in the alternative access point; instead, they are transferred from the monitoring network element along with the rerouting request. The monitoring network element is preferably an element outside access networks, allowing it to monitor data links in different access networks and reroute a data link that failed in one access network via another type of access network. This allows the state data on the data link, such as location data of the moving node, to be transferred from the monitoring network element to a new access network. The data link is preferably an IP data link and the monitoring network element is preferably a network element that also otherwise participates in managing the IP data link. In mobile IP traffic, such as in the case of a Mobile IP protocol, this network element is preferably a ‘mobility agent’, such as a mobile node's home agent in an IP home network.

The invention and its preferred embodiment operate in any network comprising a plurality of parallel access points and access concentrators, but in which only one point or concentrator can be used at a time for a session. Other access technologies can also be used as a parallel network if the spare network supports initiating the access on the network side.

Another advantage provided by the method and system of the invention is that the reliability of the GGSN elements is based on the load, which is divided between warm standby elements instead of hot standby elements and protection.

### BRIEF DESCRIPTION OF THE FIGURES

In the following the invention will be described in greater detail by means of preferred embodiments with reference to the attached drawings, in which

FIG. 1 shows the invention and its preferred embodiments in GPRS and WLAN networks;

FIG. 2 shows data link set-up according to the invention and a preferred embodiments as a signalling diagram; and

FIG. 3 shows data link set-up according to the invention and another preferred embodiment as a signalling diagram.

### DETAILED DESCRIPTION OF THE INVENTION

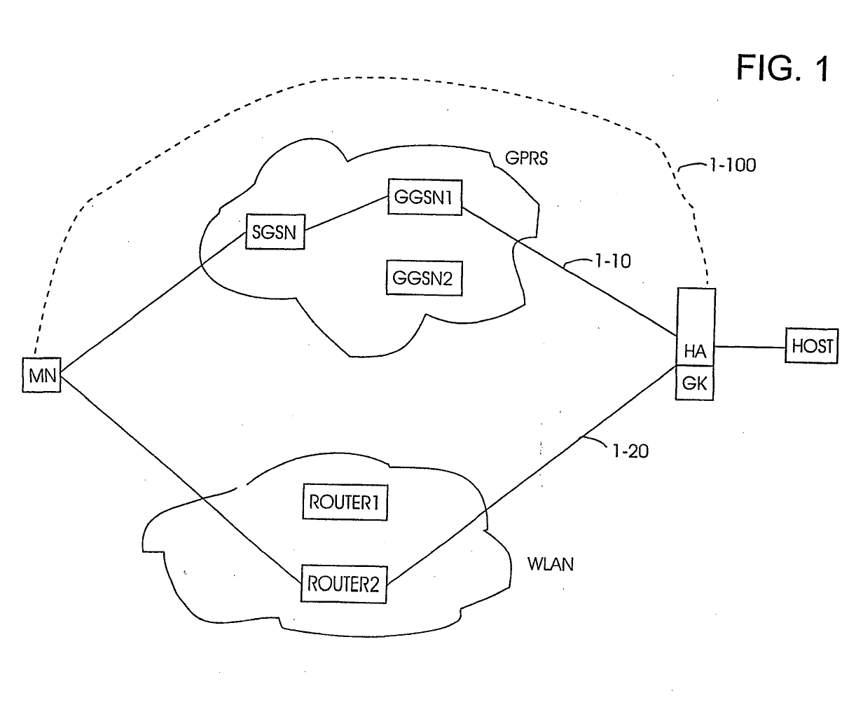

FIG. 1 shows a block diagram according to the invention and preferred embodiments, comprising, for the sake of simplicity, only two packet-switched wireless access networks, i.e. a GPRS network GPRS and a WLAN network WLAN. Only the network elements relevant to the invention and the preferred embodiments are shown.

FIG. 1 shows the following elements: a mobile subscriber node MN (Mobile Node) running the Mobile IP protocol, the node referring to an element, such as a mobile station or a computer, which is able to change its access point to the network; GPRS and WLAN are wireless access networks (Serving Access Network). A serving access network is that access network to which the MN element is linked at that particular moment. An alternative access network is an access network via which a data link can be routed in malfunction and/or if the operation of the access point becomes unreliable and/or unsuitable for communications. The alternative network may use the same technology as the current serving access network, or a different one. Rerouting can also be carried out via a second access node in the same access network.

In FIG. 1, alternative routing nodes within an access network can be used; for example alternative nodes GGSN1 and GGSN2 inside the GPRS network, or nodes ROUTER1 and ROUTER2 inside the WLAN network; the mechanism that the serving network can use to recommend an alternative data link, a gatekeeper GK, is a function or mechanism that keeps record of the movements of the moving node MN, observes the status of the serving access node or data link, detects a lost data link and reactivates the routing of the data link via the alternative access node or access network. According to the primary embodiment of the invention, an extended home agent HA supporting the Mobile IP protocol can act as the gatekeeper, denoted in FIG. 1 by the home agent HA together with a thereto-linked GK element.

In FIG. 1, reference number 1-10 denotes a first Mobile IP data link from the mobile node MN via the GPRS network and the HA element to a peer HOST. In the GPRS network, said data link passes via the SGSN element to access point GGSN1. The second access point shown in FIG. 1, the GGSN2 element, could also be used in the GPRS system. In accordance with the inventive principles, when the GGSN1 node fails, the home agent HA/GK can reroute the data link via the GPRS network's GGSN2 node or via the WLAN network acting as a spare network for the GPRS network. A data link 1-20 in FIG. 1 illustrates the data link rerouted via the WLAN system from the mobile node MN to the home agent HA. In the WLAN network, the data link passes via router ROUTER2. In FIG. 1, reference number 1-100 denotes a logic end-to-end IP data link.

The access point may provide access to either a more elaborate or a simpler wireless network. For instance, the access point may forward traffic between the wireless network and another network, possibly networks belonging to different administrative domains.

A more elaborate wireless network may comprise a radio network and a core network. The radio network may comprise for example base stations and base station controllers. The core network may comprise supporting nodes routing packet data traffic to the radio network.

The access point may also provide access to simpler wireless networks such as wireless local area networks (WLAN) comprising only a set of base stations connected to at least one network segment. The access point is thus connected to at least one of the network segments.

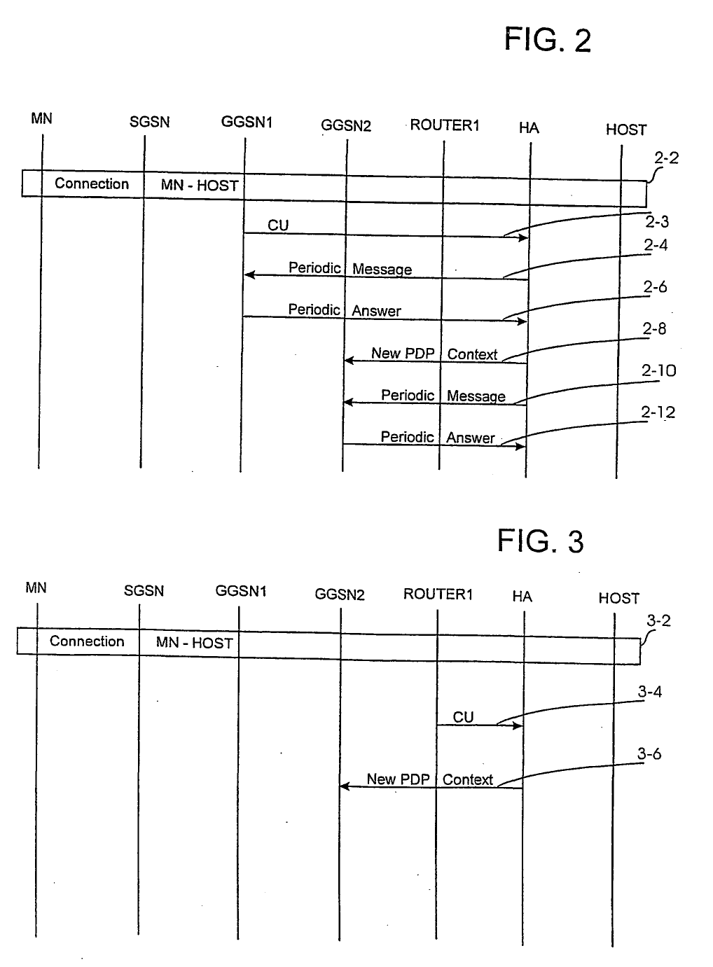

FIG. 2 shows data link protection according to the invention and a preferred embodiment as a signalling diagram, the protection occurring after a data link 1-10 is set up between a normally mobile node MN and a second host HOST in step 2-2.

When the MN establishes the data link, the data link passes via an access point. In FIG. 2, the data link 1-10 first passes via GGSN1. Hereby a PDP context is created in the GGSN1 node for the mobile node MN, as was described above. Once the PDP context is activated, the MN sends to the home agent HA a Mobile IP Registration Request message RR, in which the MN notifies its new IP address, i.e. the COA. GGSN1 detects the RR message and thereby learns the home agent's HA address. If several RR requests exist, the following steps are to be repeated for all RR requests. In the mobile IPv6 version, the RR request is replaced by a BU (Binding Update) message.

Since a malfunction can involve a single data link or the entire GGSN1 node, it would be useful for the home agent HA to know the configuration of GGSN1. When the GPRS system is used, the home agent HA can be informed of the PDP context and of the subscriber-related information necessary to enable to data link to be restored, i.e. transferred to pass via a second GGSN element. In other words, in order for the HA to be able to restore the data link using the GPRS system, for example, the HA element should have available the necessary information on the subscriber, for example. For this purpose, GGSN1 also sends to the HA, after the RR message, a context update message CU 2-3 including the telephone number of the mobile node (MSISDN, Mobile Station International Subscriber Dial-Up Number) and location (e.g. the SGSN's IP address) and any other route-related information, such as the QoS. The message may also include other information, for example on the radio channel (e.g. the QoS, Quality of Service, profile). The information included in the message may also be called context update (CU). The GGSN element may also notify the HA element of alternative GGSN elements' IP addresses. Usually the type and significance of said parameters depend on the type of network used as the alternative network. This information is stored in the home agent HA as state data on node GGSN1. GGSN1 sends a new CU message to the home agent always when the state data stored in the HA have to be updated, for example as a result of the activation of each data link and a change in area. During each SGSN handover, for example, when the state data in the HA should be updated, GGSN1 may send a new SGSN address to the HA. The necessary data may include e.g. information on the identity, the location and the QoS profile. Said updates may be called SPA (Spare Route Advertisement) messages. A change in the QoS value may also be reported to the HA.

GGSN and SGSN information may also be configured manually, and the rest of the information may be recorded when linking up with the network. The description of the identities of the different networks (e.g. user name, MSISDN and IEEE802.11 MAC address) may require the use of a client database. Controlled data link release may be mentioned as a special occasion involving the QoS value, which controls the HA element such that it does not try to re-establish the data link.

In the simplest case, the location identifier is the SGSN address. However, if several SGSN elements exist that serve the same area, the GGSN element may report to them all upon changeover. Hereby the HA element may also deal with the error in the SGSN element. The function of the HA element may also be implemented as an extension of the CSCF (Call State Control Function).

Referring again to FIG. 2, in step 24, the HA sends to GGSN1 a monitoring message. The message may be sent at given intervals, for example. The message serves to check that the element to be monitored is in working order. The message may be for instance a watchdog message, to which the HA waits for a reply for a given time. If in step 2-6 the HA does not receive a reply, response or signal within a given time indicating that GGSN1 is in working order, the HA may conclude that the operation of GGSN1 is unreliable or unsuitable for communication or that it is no longer active. The operation of said data link 1-10, 1-20 may become unsuitable for communication if for instance data link 1-10, 1-20 is in malfunction; and/or data link 1-10, 1-20 no longer fulfills satisfying quality requirements; and/or access point GGSN1, GGSN2, ROUTER1, ROUTER2 is no longer in operational state.

If RR messages or other Mobile IP messages are received sufficiently often from GGSN1, the HA does not necessarily have to send monitoring messages, but the activity of GGSN1 may be deduced by means of the other messages.

When the HA detects a situation that renders or may render the operation of GGSN1 unreliable at least partly in view of the IP data link 1-10, the HA starts rerouting for all those IP data links that may be lost upon malfunction of GGSN1. If the malfunction is a network-initiated PDP context deactivation, only one data link needs to be reconnected. In this case it must be known if the reason for the deactivation is replaceable or not. A non-replaceable reason may be associated with for example a client moving outside of the coverage area or exceeding a client's prepaid balance. In this case, some other network than the GPRS network has to be used for the data link. A deactivation caused by the client does not cause an attempt to re-establish the data link. The client is assumed to indicate a deactivation, e.g. the release of a data link, by hanging up, for example. In other words, the MN may lose a data link because it moves to the outside of the coverage area. In this case the MN itself starts to look for an alternative data link. For example, having lost a WLAN network data link, the MN may attempt to use a mobile network. Even in this case the network may detect the loss of the data link and report this to the home agent HA as malfunction, which starts changeover procedures. The GGSN may also notify the reason for releasing the PDP context. A reason may be for example that the GGSN lost the data link to the SGSN node. The WLAN controller may also report a similar malfunction when the mobile station moves to the outside of the coverage area. If a release of the original data link is due to a malfunction, the HA may attempt to establish an alternative data link. This means for example that in the WLAN base station it is detected that the radio link layer connection to the mobile station is no longer established. This radio link failure is then indicated to the HA and its monitoring means by the base station.

Referring again to FIG. 1, the HA sends to GGSN2 a message NEW PDP CONTEXT 2-8, in which it requests that a new PDP context be created for the mobile node MN. This request preferably includes information on the original PDP context, such as the SGSN address, QoS parameters and subscriber data. On the basis of these data, GGSN2 is able to create a new PDP context and transfer it further to the SGSN and the MN. Since fresh data on the accessibility of the MN (MSISDN, location, etc.) is stored in the HA and transferred to the new GGSN, the GGSN does not need a Gc interface to the GPRS registers (HLR). However, the GGSN nodes have to support the NRPCA (Network Requested PDP Context Activation) function. Furthermore, signalling between the HA and the GGSN increases slightly. The HA also needs more memory. However, these are insignificant disadvantages compared with the omission of the HLR interface and hot standby protection from the GGSN. A faulty GGSN may be replaced with another on the fly, but since one of the GGSNs does not need a real-time copy of the session information of the GGSN to be protected, it is not a hot standby unit, more like warm. In other words, the reliability of the GGSN elements is based on dividing the load between warm standby elements in place of hot standby elements and protection.

One important economic advantage provided by the method and the system of the invention and its embodiments is thus that the warm standby unit does not need redundancy for every secured unit but only one common spare element.

If the GGSN element with a failure can be replaced by dividing the load between the elements without a failure, no redundant elements are needed.

This way a new data link that passes the faulty GGSN1 is routed via GGSN2. The MN again sends a Mobile IP RR message and a procedure similar to the one described above for GGSN1 starts to monitor also GGSN2. In other words, GGSN2 sends a CU message, the HA sends a periodic message 2-10, and GGSN2 sends a periodic reply 2-12.

The HA is also able to route the data link via an access network, such as the WLAN network or the Bluetooth network, that uses a different technology. This spare network has to support data link set-up initiated from the network side. In other words, when the HA sends a data link set-up request to router ROUTER1 in the WLAN network, the router has to be able to set up the data link further to the mobile node MN. Even in this case the request sent by the HA includes information on the subscriber, location and data link parameters, such as QoS parameters.

Similarly, in accordance with the invention, an IP data link can be transferred from the WLAN network to the GRPS network. FIG. 3 shows data link protection according to the invention and a preferred embodiment as a signalling diagram, the protection occurring after a data link is set up between a normally mobile node MN and a second peer HOST in step 3-2 via the WLAN network. The WLAN access point, such as router ROUTER1 or ROUTER2, which handles access to the IP network, can send in step 34 to the HA element a CU message including enough status information for the HA to be able to transfer active sessions to the GPRS system if the HA detects a malfunction in router ROUTER1 or ROUTER2. The HA sends to GGSN2 a NEW PDP CONTEXT message 3-6 including the same data as in the above example of FIG. 2. The HA is able to set up a GPRS data link since the location of the mobile node MN is known to be within the WLAN coverage area, which is always smaller than the area covered by one SGSN element.

A CU message may be implemented as an application protocol message. The message can be implemented as a proprietary message or as an extension of the Mobile IP protocol. The syntax of the message can be defined for example as triplets, the triplet comprising information on type-length-value, for example. Each message may comprise one or more area codes and alternative GGSN element addresses. The semantics used by the fields depend on the access network technology.

A CU message does not have to be reliable. The data link is not harmed by a corrupt or lost CU message unless the data link fails before the next valid CU message. However, a working CU message has to be incorrupt and verified by two operators, one of which sends said CU message and the suggested spare link service. The operators are the same if intra-network alternative link service only is requested.

In the GPRS environment, the GGSN may send an FHAE (Foreign Host Authentication Extension) equivalent message. If the network between the GGSN and the HA is public, encryption may also be requested since a CU message reveals information on the operator's infrastructure.

A re-access request may also be protected. The HA has to sign for the request in a manner allowing the network carrying out the alternative link service to verify the validity of the request. Upon arrival at the terminal MN, a request has to be able to be detected as coming from a reliable source. This requirement can be fulfilled with physical means. In other words, the MN relies on the network signal being protected and the operator having verified the request.

The invention and its preferred embodiments allow for example the following problems to be solved:

1) An operator wants an extremely safely operating access point.

2) A user moves from one access network to another access network.

The invention and its preferred embodiments operate in any network comprising a plurality of parallel access points or access concentrators, but in which only one point or concentrator is used at a time for one session. An example is the GPRS network and the GGSN as one error point per PDP data link. Other access technologies may also be used as the parallel network provided the spare network supports the accesses from the network side. A network that is capable of performing a network-originating link update can be used as the alternative system. As was stated above, the invention is thus usable in mixed networks, an example being the use of a GPRS network for protecting a WLAN network, and vice versa.

The delay between the detection of an error in an access point and the set-up of a new data link can be used as a design parameter. The delay may be defined to be for example below one second provided an increased amount of traffic is acceptable from the watchdog timer.

It is obvious to a person skilled in the art that, as technology advances, the inventive concept can be implemented in a variety of ways. Thus the invention and its embodiments are not limited to the above examples but may vary within the scope of the claims.

1. A method of protecting a data link (1-10, 1-20) established via an access point (GGSN1, GGSN2, ROUTER1, ROUTER2) to a mobile subscriber node (MN), characterized by the following steps:
(i) a monitoring network element (HA) monitors the operation of the data link (1-10, 1-20);
(ii) in case the operation of the data link (1-10, 1-20) becomes unsuitable for communication, the monitoring network element (HA) starts to set up an alternative data link (1-10, 1-20) via an alternative access point (GGSN1, GGSN2, ROUTER1, ROUTER2); and
(iii) after the alternative data link has been set up, the mobile subscriber node (MN) completes a Mobile IP handover to it.

2. A method as claimed in claim 1, characterized in that the access point (GGSN1, GGSN2, ROUTER1, ROUTER2) provides access to a wireless network.

3. A method as claimed in claim 2, characterized in that the wireless network is a radio access network, WLAN or Bluetooth network.

4. A method as claimed in claim 3, characterized in that the access point (GGSN1, GGSN2, ROUTER1, ROUTER2) is an access point, e.g. a GGSN element of a GRPS data link, of said access network.

5. A method as claimed in any one of the preceding claims, characterized by the observation of the data link (1-10, 1-20) involves the monitoring of the state of the access point (GGSN1, GGSN2, ROUTER1, Router2).

6. A method as claimed in any one of the preceding claims, characterized by the fact that the operation of said data link (1-10, 1-20) becomes unsuitable for communication if
the data link (1-10, 1-20) is in malfunction; and/or
the data link (1-10, 1-20) is no longer fulfilling satisfying quality requirements; and/or
access point (GGSN1, GGSN2, ROUTER1, ROUTER2) is no longer in operational state.

7. A method as claimed in any one of the preceding claims, characterized by
the monitoring element (HA) storing state data on the network element to be monitored, the data being related to the link(s) to be protected, and
the state data being transferred from the monitoring network element (HA) to the alternative access point along with a rerouting request.

8. A method as claimed in any one of the preceding claims, characterized by the monitoring network element (HA) being an element outside the access network.

9. A method as claimed in any one of the preceding claims, characterized by the link being an IP data link and the monitoring network element (HA) being a network element participating in the mobility management of the mobile node on the IP protocol level.

10. A method as claimed in claim 9, characterized by the data link (1-10, 1-20) being a data link that uses the Mobile IP mobility management protocol.

11. A method as claimed in claim 9 or 10, characterized by the monitoring network element (HA) being the home agent (HA) of the Internet home network of the mobile node (MN).

12. A method as claimed in any one of the preceding claims, characterized by the monitoring network element (HA) monitoring the activity of the access point (GGSN1, GGSN2, ROUTER1, ROUTER2).

13. A method as claimed in claim 12, characterized by the home agent (HA) of the Internet home network of the mobile node (MN) monitoring Mobile IP registration messages arriving via the access point (GGSN1, GGSN2, ROUTER1, ROUTER2).

14. A method as claimed in claim 12, characterized by the home agent (HA) of the Internet home network of the mobile node (MN) sending inquiry messages and waiting for replies, and the home agent (HA) of the Internet home network of the mobile node (MN) assuming the access point (GGSN1, GGSN2, ROUTER1, ROUTER2) failed and directing the data link (1-10, 1-20) to use the alternative link (1-10, 1-20) in case it receives no reply.

15. A network element (HA) monitoring the Internet data link of a mobile node, characterized in that
(i) the monitoring network element (HA) is arranged to observe the operation of a data link (1-10, 1-20)
(ii) in case the operation of the data link (1-10, 1-20) becomes unsuitable for communication, the monitoring network element (HA) starts to set up an alternative data link (1-10, 1-20) via an alternative access point (GGSN1, GGSN2, ROUTER1, ROUTER2).

16. A network element as claimed in claim 15, characterized in that
the monitoring element (HA) is arranged to store state data on the network element to be observed, the data being related to the link(s) to be protected, and
the state data are transferred from the monitoring network (HA) element to the alternative access point (GGSN1, GGSN2, ROUTER1, ROUTER2) along with a rerouting request.

17. A network element as claimed in claim 15 or 16, characterized in that the monitoring network (HA) element is an element outside the access network.

18. A network element as claimed in claim 15, 16 or 17, characterized in that the monitoring network element (HA) is a network element participating in the mobility management of the mobile node on the IP protocol level.

19. A network element as claimed in claim 15, characterized in that the data link (1-10, 1-20) is a data link that uses the Mobile IP mobility management protocol.

20. A network element as claimed in claims. 15 to 18, characterized in that the monitoring network element (HA) is the home agent (HA) of the Internet home network of the mobile node (MN).

21. A network element as claimed in claims 15 to 20, characterized in that the monitoring network element (HA) monitors the activity of the access point (GGSN1, GGSN2, ROUTER1, ROUTER2).

22. A network element as claimed in claim 20, characterized in that the home agent (HA) of the Internet home network of the mobile node (MN) monitors Mobile IP registration messages arriving via the access point (GGSN1, GGSN2, ROUTER1, ROUTER2).

23. A network element as claimed in claim 22, characterized in that the home agent (HA) of the Internet home network of the mobile node (MN) sends inquiry messages and waits for replies, and the home agent (HA) of the Internet home network of the mobile node (MN) assumes the access point (GGSN1, GGSN2, ROUTER1, ROUTER2) failed and directs the data link (1-10, 1-20) to use the alternative link (1-10, 1-20) in case it receives no reply.

24. An access network comprising at least one centralized router or gateway (GGSN1, GGSN2, ROUTER1, ROUTER2) via which an IP data link.
(1-10, 1-20) is set up from an outside data network to a mobile subscriber node (MN), characterized in that
said router or gateway is arranged to send state data associated with the link to an outside network element that monitors the operation of the router or gateway to protect said IP data link, and
said router or gateway is responsive to a set-up request that is sent by said network element and comprises data on a data link that was set up via another router or gateway to a mobile node but failed, for setting up an IP data link from said router or gateway to said mobile node on the basis of said received data.

25. An access network as claimed in claim 24, characterized in that said router or gateway is arranged to send to said outside network element data on alternative protective routers or gateways in the same or a different access network.

26. An access network as claimed in claim 24 or 25, characterized in that said router or gateway is arranged to send a reply message in response to said monitoring message sent by the outside element.

27. An access network as claimed in claim 24, 25 or 26, characterized in that said gateway is a gateway node in a packet radio network.

28. An access network as claimed in claim 24 to 27, characterized in that the access point (GGSN1, GGSN2, ROUTER1, ROUTER2) provides access to a wireless network.
